(19) United States
(12) Patent Application Publication
(10) Pub. No.: US 2022/0398558 A1
(43) Pub. Date: Dec. 15, 2022

(54) INFORMATION PROCESSING APPARATUS AND INFORMATION PROCESSING SYSTEM

(71) Applicant: Toshiba Tec Kabushiki Kaisha, Tokyo (JP)

(72) Inventor: Eiji UEMURA, Yokohama Kanagawa (JP)

(73) Assignee: Toshiba Tec Kabushiki Kaisha, Tokyo (JP)

(21) Appl. No.: 17/669,035

(22) Filed: Feb. 10, 2022

(30) Foreign Application Priority Data
Jun. 10, 2021 (JP) 2021-097538

(51) Int. Cl. G06Q 20/20

(52) U.S. Cl. CPC G06Q 20/208

(57) ABSTRACT

A technique capable of preventing a purchased commodity from being forgotten to be passed to a customer is provided. An information processing apparatus includes a determination unit, an update unit, and a display control unit. The determination unit determines a change in weight of commodities measured by a weight sensor provided in a placing portion. The update unit updates a first total placement number of commodities on the placing portion based on the determination of the change in weight by the determination unit. The display control unit causes a display unit to display the first total placement number updated by the update unit.

### CROSS-REFERENCE TO RELATED APPLICATION

This application is based upon and claims the benefit of priority from Japanese Patent Application No. 2021-097538, filed on Jun. 10, 2021, the entire contents of which are incorporated herein by reference.

### FIELD

Embodiments described herein relate generally to an information processing apparatus and an information processing system.

### BACKGROUND

In a store such as a specialty store, a store clerk often performs operations from registration to settlement on a purchased commodity in a face-to-face type point of sales (POS) terminal, and packs the purchased commodity in a bag. At this time, in a situation in which the store clerk forgets to put the registered purchased commodity into the bag, or the like, the store clerk may forget to pass the purchased commodity to a customer.

### DESCRIPTION OF THE DRAWINGS

FIG. 1 is a block diagram illustrating an information processing system according to at least one embodiment;

FIG. 2 is a block diagram schematically illustrating a configuration example of a POS terminal according to at least one embodiment;

FIG. 3 is a diagram illustrating a configuration example of commodity information according to at least one embodiment;

FIG. 4 is a flowchart illustrating an example of a procedure of an information process performed by the POS terminal;

FIG. 5 is a flowchart illustrating another example of the procedure of the information process; and

FIG. 6 is a flowchart illustrating still another example of the procedure of the information process.

### DETAILED DESCRIPTION

In general, according to at least one embodiment, a technique capable of preventing a purchased commodity from being forgotten to be passed to a customer is provided.

An information processing apparatus according to an embodiment includes a determination unit, an update unit, and a display control unit. The determination unit is configured to determine a change in weight of commodities measured by a weight sensor provided in a placing portion. The update unit is configured to update a first total placement number of commodities on the placing portion based on the determination of the change in weight by the determination unit. The display control unit is configured to cause a display unit to display the first total placement number updated by the update unit.

Hereinafter, an embodiment will be described with reference to drawings. In the drawings, the same components are denoted by the same reference numerals as much as possible, and redundant description will be omitted.

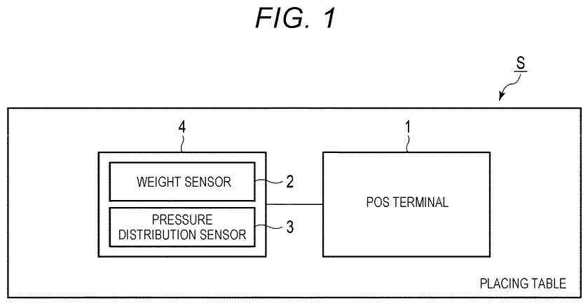

FIG. 1 is a block diagram illustrating an information processing system S according to at least one embodiment.

The information processing system S is a system applicable to a store such as a specialty store. The information processing system S is a system with which a store clerk can perform operations from registration to settlement of a purchased commodity of a customer. The store clerk may be interpreted as a user, an operating person, an operator, or a person. The customer may be interpreted as a member, a consumer, or a person.

The information processing system S includes a POS terminal 1, a weight sensor 2, and a pressure distribution sensor 3. The POS terminal 1, the weight sensor 2, and the pressure distribution sensor 3 are provided on a placing table. The placing table may be a counter on which registration and settlement of a purchased commodity are performed. The placing table includes a placing portion 4. The placing portion 4 is a region on which a plurality of registered purchased commodities can be placed. The weight sensor 2 and the pressure distribution sensor 3 are provided on the placing portion 4. The POS terminal 1 is communicably connected to the weight sensor 2 and the pressure distribution sensor 3 via cables. The information processing system S may refer to a system including at least two of the POS terminal 1, the weight sensor 2, and the pressure distribution sensor 3. The purchased commodity is also simply referred to as a commodity.

The POS terminal 1 is an electronic device that can perform the settlement on a commodity. The settlement is payment of a price for a commodity. The settlement includes meaning of checkout. The POS terminal 1 is compatible with both offline settlement and online settlement. The offline settlement is settlement in which the POS terminal 1 does not need to cooperate with other electronic devices via the Internet or the like. For example, the offline settlement is settlement using cash, a gift certificate, or the like. The online settlement is settlement executed by the POS terminal 1 in cooperation with another electronic device via the Internet or the like. Examples of the online settlement include credit card settlement, electronic money settlement, credit card, debit card settlement, and code settlement. The online settlement corresponds to cashless settlement. The POS terminal 1 is an example of an information processing apparatus. A configuration example of the POS terminal 1 will be described later.

The weight sensor 2 is an example of a sensor that is provided on the placing portion 4 and measures a weight of articles placed on the placing portion 4. The weight sensor 2 measures a total weight of articles placed on the placing portion 4. The weight sensor 2 outputs weight data indicating the weight measured in a detection range. The weight sensor 2 outputs the weight data to the POS terminal 1. The weight sensor 2 is also simply referred to as a sensor. In the following description, “measure” may be interpreted as detect, sense, or acquire.

The pressure distribution sensor 3 is an example of a sensor that is provided on the placing portion 4 and measures a pressure distribution in the placing portion 4 according to articles placed on the placing portion 4. The pressure distribution sensor 3 measures a pressure distribution in the placing portion 4 according to a plurality of articles placed on the placing portion 4. The pressure distribution sensor 3 outputs pressure distribution data indicating the pressure distribution measured in a detection range. The pressure distribution sensor 3 outputs the pressure distribution data to the POS terminal 1. The pressure distribution sensor 3 is also simply referred to as a sensor. The pressure distribution sensor 3 may be provided in a region same as the region in which the weight sensor 2 is provided.

The configuration example of the POS terminal 1 will be described.

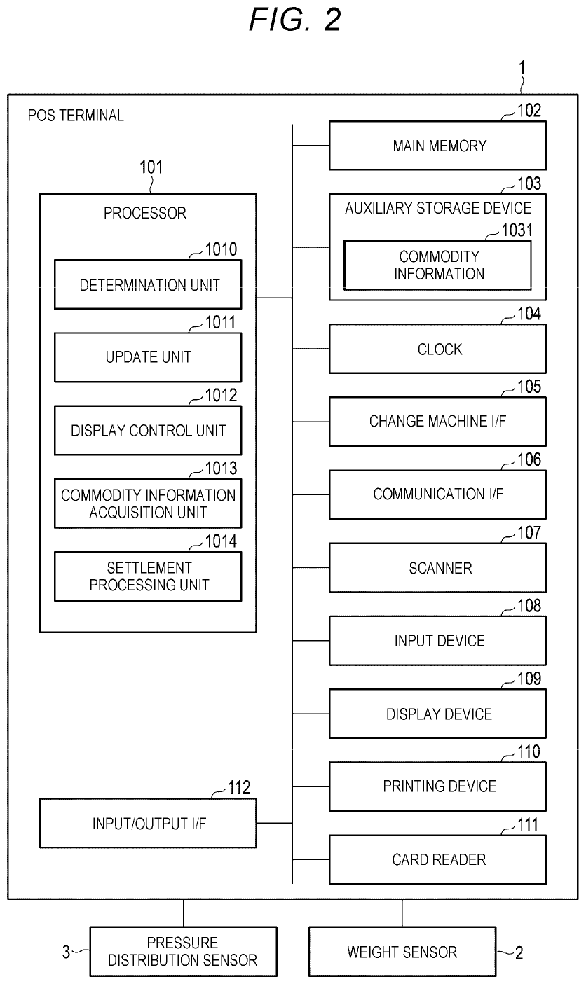

FIG. 2 is a block diagram schematically illustrating the configuration example of the POS terminal 1.

The POS terminal 1 is an electronic device including a processor 101, a main memory 102, an auxiliary storage device 103, a clock 104, a change machine interface 105, a communication interface 106, a scanner 107, an input device 108, a display device 109, a printing device 110, a card reader 111, and an input/output interface 112. The processor 101, the main memory 102, the auxiliary storage device 103, the clock 104, the change machine interface 105, the communication interface 106, the scanner 107, the input device 108, the display device 109, the printing device 110, the card reader 111, and the input/output interface 112 are connected so as to be capable of receiving and outputting signals from and to one another. In FIG. 2, the interface is described as “I/F”.

The processor 101 corresponds to a central portion of the POS terminal 1. For example, the processor 101 is a central processing unit (CPU), but is not limited thereto. The processor 101 may be formed of various circuits. The processor 101 loads a program stored in advance in the main memory 102 or the auxiliary storage device 103 into the main memory 102. The program is a program that causes the processor 101 of the POS terminal 1 to implement or execute each unit to be described later. The processor 101 executes various operations by executing the program loaded in the main memory 102.

The main memory 102 corresponds to a main storage portion of the POS terminal 1. The main memory 102 includes a non-volatile memory region and a volatile memory region. The main memory 102 stores an operating system or the program in the non-volatile memory region. The main memory 102 uses the volatile memory region as a work area in which data is appropriately rewritten by the processor 101. For example, the main memory 102 includes a read only memory (ROM) as the non-volatile memory region. For example, the main memory 102 includes a random access memory (RAM) as the volatile memory region. The main memory 102 stores the program.

The auxiliary storage device 103 corresponds to an auxiliary storage portion of the POS terminal 1. The auxiliary storage device 103 is an electric erasable programmable read-only memory (EEPROM (registered trademark)), a hard disc drive (HDD), a solid state drive (SSD), or the like. The auxiliary storage device 103 stores the above-described programs, data used when the processor 101 performs various processes, and data generated by the processor 101 performing the processes. The auxiliary storage device 103 is an example of a storage unit.

The auxiliary storage device 103 includes commodity information 1031.

The commodity information 1031 includes records for respective commodities each including data in which a commodity code, a standard weight of the commodity, a lightweight flag, and the like are associated with each other. Each record included in the commodity information 1031 corresponds to the commodity information. The commodity information 1031 is information unique to each commodity. The commodity code is unique identification information assigned to each commodity in order to individually identify the commodity. The commodity code may be a Japanese Article Number (JAN) code. The standard weight of the commodity is a standard weight of each commodity. The light weight flag is a flag indicating that the standard weight of the commodity is equal to or less than a predetermined weight. The predetermined weight is, for example, 1 gram, 0.5 gram, or the like. The predetermined weight may be set in advance, or may be appropriately set by an administrator or the like of the store.

The light weight flag may be 1-bit information for identifying whether the commodity specified by the commodity code is a commodity having a standard weight equal to or less than the predetermined weight. A commodity having a standard weight equal to or less than the predetermined weight is, for example, a stamp, a claim check, a ticket, or the like. In at least one embodiment, a light weight flag of a commodity having a standard weight equal to or less than the predetermined weight is set to “1”, and a light weight flag of a commodity having a standard weight not equal to or less than the predetermined weight is set to “0”.

The commodity information 1031 may include information such as a commodity name, a commodity type, and a commodity price. Details of the commodity information 1031 will be described later.

The clock 104 functions as a time information source of the POS terminal 1. The processor 101 times a current date and time based on time information timed by the clock 104.

The change machine interface 105 receives and outputs data signals from and to an automatic change machine (not illustrated). For example, the change machine interface 105 receives input amount data from the automatic change machine. The change machine interface 105 outputs change amount data to the automatic change machine. The automatic change machine dispenses bills or coins corresponding to a change amount according to the change amount data.

The communication interface 106 includes various interfaces for communicably connecting the POS terminal 1 to other electronic devices via a network in accordance with a predetermined communication protocol.

The scanner 107 scans and reads a barcode or the like of a commodity held over a reading window. A barcode symbol obtained by converting a commodity code for identifying a commodity sold in a store into a barcode is attached to the commodity. The scanner 107 reads the barcode every time the barcode symbol attached to the commodity is held over the reading window. Here, the barcode may be interpreted as a two-dimensional data code. The scanner 107 may be of a type that reads the code symbol by scanning the code symbol with a laser beam. The scanner 107 may be of a type that reads the code symbol from an image captured by an imaging device such as a camera.

The input device 108 is a device that functions as a data input interface to the POS terminal 1. For example, the input device 108 is a keyboard, a touch panel, or the like.

The display device 109 is a device capable of displaying various screens under control of the processor 101. Different display devices 109 may be provided as a device for a store clerk and a device for a customer. For example, the display device 109 is a liquid crystal display, an electroluminescence (EL) display, or the like. The display device 109 is an example of a display unit.

The printing device 110 is a device for printing receipts, slips, or the like. For example, the printing device 110 is a thermal printer, an inkjet printer, or the like.

The card reader 111 reads card data recorded in a magnetic stripe of a card medium.

The input/output interface 112 is an interface connected to the weight sensor 2 and the pressure distribution sensor 3 via cables. The input/output interface 112 includes a cable connector.

A hardware configuration of the POS terminal 1 is not limited to the above-described configuration. In the POS terminal 1, the above-described components can be appropriately omitted and changed, and new components can be added.

Each unit implemented by the above-described processor 101 will be described.

The processor 101 includes a determination unit 1010, an update unit 1011, a display control unit (controller) 1012, a commodity information acquisition unit (commodity information receiver) 1013, and a settlement processing unit (settlement processor) 1014. Each unit implemented by the processor 101 can also be referred to as a function. Each unit implemented by the processor 101 can also be regarded as being implemented by a control unit (controller) including the processor 101 and the main memory 102.

The determination unit 1010 acquires, from the weight sensor 2 via the communication interface 106, weight data indicating a weight of commodities placed on the placing portion 4 that is measured by the weight sensor 2. The weight data is a total weight of commodities placed on the placing portion 4. The determination unit 1010 determines a change in weight measured by the weight sensor 2 based on the acquired weight data. The determination unit 1010 acquires, from the pressure distribution sensor 3 via the communication interface 106, the pressure distribution data indicating the pressure distribution in the placing portion 4 according to the commodities placed on the placing portion 4 that is measured by the pressure distribution sensor 3. The pressure distribution in the placing portion 4 according to the commodities placed on the placing portion 4 is also referred to as the pressure distribution of the commodities placed on the placing portion 4. The determination unit 1010 determines a change in the number of commodities on the placing portion 4 based on the acquired pressure distribution data.

The update unit 1011 calculates the number of commodities placed on the placing portion 4. For example, the update unit 1011 calculates the number of commodities placed on the placing portion 4 based on the change in weight determined by the determination unit 1010. The update unit 1011 calculates the number of commodities placed on the placing portion 4 based on the changed weight and the standard weights of the commodities placed on the placing portion 4. The update unit 1011 calculates the number of commodities placed on the placing portion 4 based on the change in the number of commodities on the placing portion 4 based on the pressure distribution data. In the following description, “calculate” may be interpreted as detect, sense, or acquire.

The update unit 1011 updates a total number of commodities placed on the placing portion 4. For example, the update unit 1011 updates a first total placement number of commodities on the placing portion 4 based on the number of commodities calculated based on the change in weight on the placing portion 4. The first total placement number is a total number of commodities placed on the placing portion 4 based on the weight data measured by the weight sensor 2. The update unit 1011 updates a second total placement number of commodities on the placing portion 4 based on the number of commodities calculated based on the change in pressure distribution on the placing portion 4. The second total placement number is a total number of commodities placed on the placing portion 4 based on the pressure distribution data measured by the pressure distribution sensor 3.

The display control unit 1012 causes the display device 109 to display various types of data. For example, the display control unit 1012 causes the display device 109 to display a total number of commodities registered via the scanner 107. The total number of commodities registered via the scanner 107 is an example of a total number of registered commodities. The display control unit 1012 causes the display device 109 to display the first total placement number updated by the update unit 1011. The display control unit 1012 causes the display device 109 to display a comparison result between the total number of registered commodities and the first total placement number. The display control unit 1012 causes the display device 109 to display the second total placement number updated by the update unit 1011. The display control unit 1012 causes the display device 109 to display a comparison result between the total number of registered commodities and the second total placement number. The display control unit 1012 causes the display device 109 to display a notification based on the comparison result. The notification is, for example, a notification indicating that the total number of registered commodities is different from the first total placement number. The notification is, for example, a notification indicating that the total number of registered commodities is different from the second total placement number. The notification is, for example, a notification indicating that the first total placement number is different from the second total placement number.

The commodity information acquisition unit 1013 acquires commodity information on the commodities registered via the scanner 107 based on the commodity information 1031.

The settlement processing unit 1014 executes a settlement process. For example, the settlement processing unit 1014 executes the settlement process according to selection of a payment method by a customer. The payment method includes the offline settlement and the online settlement.

A configuration example of the commodity information 1031 will be described.

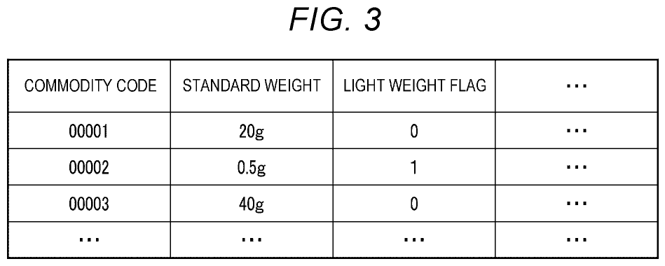

FIG. 3 is a diagram illustrating the configuration example of the commodity information 1031. The commodity information 1031 includes a “commodity code” item, a “standard weight” item, and a “light weight flag” item. The “commodity code” item is an item for setting the commodity code. The “standard weight” item is an item for setting the standard weight of each commodity. The “light weight flag” item is an item for setting the light weight flag. Each of the plurality of commodity codes is associated with the standard weight and the light weight flag as the commodity information record in the commodity information 1031. For example, the commodity information 1031 stores a fact that the standard weight is 20 grams and the light weight flag is “0” for a commodity code “00001”. The light weight flag of “0” indicates that the standard weight of the commodity associated with the commodity code is not equal to or less than the predetermined weight. The commodity information 1031 stores a fact that the standard weight is 0.5 grams and the light weight flag is “1” for a commodity code “00002”. The light weight flag of “1” indicates that the standard weight of the commodity associated with the commodity code is equal to or less than the predetermined weight. In this example, it is assumed that the predetermined weight is 0.5 grams. The information included in the commodity information 1031 may be set as appropriate. The POS terminal 1 appropriately updates the commodity information 1031.

A procedure of a process performed by the information processing system S will be described.

In the following description based on the POS terminal 1, the POS terminal 1 may be interpreted as the processor 101. The procedure of the process described below is merely an example, and each processing may be changed in a possible range. In the procedure of the process described below, an action may be appropriately omitted, replaced, and added according to the embodiment.

Here, it is assumed that a store clerk operates the POS terminal 1 to register purchased commodities of a customer via the scanner 107. Every time a purchased commodity is registered, the store clerk places the registered purchased commodity on the placing portion 4. The weight sensor 2 and the pressure distribution sensor 3 output a measurement result to the POS terminal 1 every time the store clerk places the purchased commodity on the placing portion 4.

In response to reading of a commodity code of the purchased commodity by the store clerk via the scanner 107, the POS terminal 1 performs the following information processing. Hereinafter, a case in which a commodity A is read by the store clerk via the scanner 107 will be described as an example. It is assumed that every time the store clerk registers the commodity A via the scanner 107, the store clerk places the registered commodity A on the placing portion 4. The store clerk may register the commodity A via the scanner 107 and register a plurality of commodities A via a plurality button or the like. In this case, it is assumed that the store clerk places the plurality of registered commodities A on the placing portion 4 every time the store clerk registers the plurality of commodities A via the plurality button or the like. The plurality button is numeric keys or the like for indicating the number of commodities to be registered.

The procedure of the process performed by the POS terminal 1 will be described.

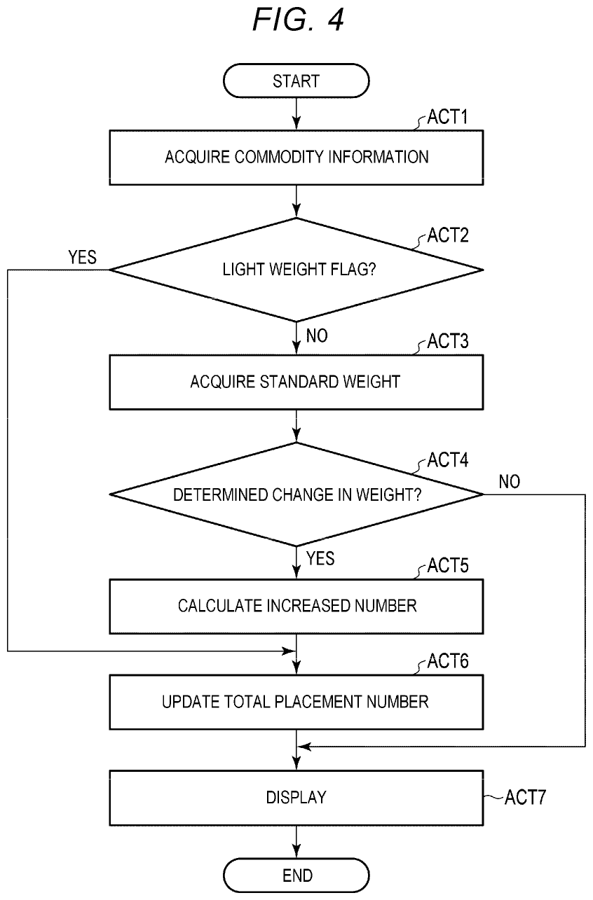

FIG. 4 is a flowchart illustrating an example of a procedure of information processing performed by the processor 101 of the POS terminal 1. In this example, an example of a procedure of information processing using the measurement result of the weight sensor 2 will be described.

The commodity information acquisition unit 1013 acquires commodity information on the commodity A registered via the scanner 107 based on the commodity information 1031 (ACT 1). In ACT 1, for example, the commodity information acquisition unit 1013 acquires the commodity information on the commodity Ain response to the reading of the commodity code of the commodity A by the store clerk via the scanner 107. The commodity information acquisition unit 1013 refers to the commodity information 1031 and acquires information on the standard weight and the light weight flag of the commodity A. The processor 101 stores the number of registered commodities via the scanner 107 in the auxiliary storage device 103. In one example, every time the store clerk registers the commodity via the scanner 107, the processor 101 stores each number of commodities in the auxiliary storage device 103. In another example, every time the store clerk registers, via the plurality button or the like, a plurality of commodities the same as a commodity registered via the scanner 107, the processor 101 stores each number of registered commodities in the auxiliary storage device 103. The processor 101 adds up each number of registered commodities and stores a total number of registered commodities in the auxiliary storage device 103.

The commodity information acquisition unit 1013 determines whether the commodity A is a light weight commodity based on the acquired commodity information on the commodity A (ACT 2). The light weight commodity is an example of a commodity having a standard weight equal to or less than a predetermined weight. In ACT 2, for example, the commodity information acquisition unit 1013 determines whether the light weight flag of the commodity A is set to “1”. If the commodity information acquisition unit 1013 determines that the light weight flag is set to “1” (ACT 2: YES), the process transitions from ACT 2 to ACT 6. If the commodity information acquisition unit 1013 determines that the light weight flag is not set to “1” (ACT 2: NO), the process transitions from ACT 2 to ACT 3.

For example, if the commodity A is the commodity having the commodity code “00001”, the commodity information acquisition unit 1013 determines that the standard weight of the commodity A is not equal to or less than the predetermined weight based on the light weight flag of the commodity A being 0″.

The commodity information acquisition unit 1013 acquires the standard weight of the commodity A based on the acquired commodity information on the commodity A (ACT 3). For example, if the commodity A is the commodity having the commodity code “00001”, the commodity information acquisition unit 1013 acquires “20 grams” as the standard weight of the commodity A.

The determination unit 1010 determines a change in weight of the commodities measured by the weight sensor 2 provided in the placing portion 4 (ACT 4). In ACT 4, for example, the determination unit 1010 acquires, from the weight sensor 2 via the communication interface 106, the weight data indicating the weight of the commodity placed on the placing portion 4 that is measured by the weight sensor 2. Based on the weight data, the determination unit 1010 compares a weight before the commodity A is placed on the placing portion 4 with the weight based on the weight data. The determination unit 1010 determines whether a total weight of the commodity placed on the placing portion 4 is changed based on a comparison result. The determination unit 1010 stores a determined change amount of the weight in the auxiliary storage device 103. For example, if the weight before the commodity A is placed on the placing portion 4 is 100 grams and the weight based on the weight data is 140 grams, the determination unit 1010 determines that the total weight of the commodity placed on the placing portion 4 is changed. The determination unit 1010 stores 40 grams as the determined change amount of the weight in the auxiliary storage device 103. The determined change amount of the weight is also referred to as a change weight.

If the determination unit 1010 determines that the weight of the commodity placed on the placing portion 4 is changed (ACT 4: YES), the process transitions from ACT 4 to ACT 5. If the determination unit 1010 determines that the weight of the commodity placed on the placing portion 4 is not changed (ACT 4: NO), the process transitions from ACT 4 to ACT 7.

The update unit 1011 calculates an increased number of commodities placed on the placing portion 4 based on the change weight determined by the determination unit 1010 (ACT 5). The increased number is, for example, a changed number of commodities on the placing portion 4 before and after the commodity A is placed on the placing portion 4. In ACT 5, for example, the update unit 1011 calculates an increased number of commodities A placed on the placing portion 4 based on the change weight and the standard weight of the commodity A acquired in ACT 3. The update unit 1011 calculates a value obtained by dividing the change weight by the standard weight of the commodity A as the increased number of commodities A. For example, a case in which the commodity A is the commodity having the commodity code “00001” and the change weight is 40 grams will be described. The update unit 1011 calculates a value (=2) obtained by dividing the change weight “40 grams” by the standard weight “20 grams” of the commodity A as the increased number of commodities A. The update unit 1011 calculates an integer close to a value obtained by dividing a change weight by a standard weight of a commodity as the increased number. For example, if the value obtained by dividing the change weight by the standard weight of the commodity is 1.2, the update unit 1011 calculates 1 as the increased number of commodities. The determination unit 1010 stores the calculated increased number in the auxiliary storage device 103.

The update unit 1011 updates the first total placement number of commodities on the placing portion 4 (ACT 6).

In one example, the update unit 1011 updates the first total placement number of commodities placed on the placing portion 4 in response to the determination that the commodity A is a light weight commodity in ACT 2. In this case, the update unit 1011 acquires the number of commodities A stored in the auxiliary storage device 103. The update unit 1011 adds the acquired number of commodities A to the first total placement number. A case in which the commodity A is the commodity having the commodity code “00002” and the store clerk registers the commodity A two times will be described. The update unit 1011 acquires the number “2” of registered commodities A from the auxiliary storage device 103. The update unit 1011 adds the number “2” of commodities A to the first total placement number.

In another example, the update unit 1011 updates the first total placement number of commodities placed on the placing portion 4 based on the increased number of commodities calculated in ACT 5. In this case, the update unit 1011 adds the increased number “2” of commodities A to the first total placement number.

The display control unit 1012 controls the display of the display device 109 (ACT 7).

The display control unit 1012 causes the display device 109 to display the total number of registered commodities registered via the scanner 107. For example, every time a commodity is registered, the display control unit 1012 acquires the total number of registered commodities stored in the auxiliary storage device 103. The display control unit 1012 causes the display device 109 to display the acquired total number of registered commodities. Alternatively, every time a commodity is registered, the display control unit 1012 may acquire each total number of registered commodities from the auxiliary storage device 103 in addition to the total number of registered commodities or instead of the total number of registered commodities, and cause the display device 109 to display each total number of registered commodities.

The display control unit 1012 causes the display device 109 to display the first total placement number updated by the update unit 1011. Alternatively, every time a weight of a commodity placed on the placing portion 4 is measured by the weight sensor 2, the display control unit 1012 may cause the display device 109 to display each total placement number of commodities in addition to the first total placement number or instead of the first total placement number.

The display control unit 1012 causes the display device 109 to display the comparison result between the total number of registered commodities and the first total placement number. If the first total placement number is different from the total number of registered commodities based on the comparison result, the display control unit 1012 may display the first total placement number in a display form different from that of the total number of registered commodities. The display form includes: character decoration such as a character color, a size, a font, a character box, brightness, and luminance; a background color; brightness or luminance of a background; a background pattern; a frame color; blinking display; and the like. For example, if the total number of registered commodities is 10 and the first total placement number is 9, the display control unit 1012 displays characters of the first total placement number in a color different from a color of characters of the total number of registered commodities. The different color is, for example, red. The display control unit 1012 may also cause the display device 109 to display a notification based on the comparison result. The notification is, for example, a text display indicating that the first total placement number is different from the total number of registered commodities. The display control unit 1012 may cause the display device 109 to display the notification in any form such as a symbol, an icon, or a video. The processor 101 may cause a sound output device (not illustrated) to output the notification as a sound.

The display control unit 1012 may cause the display device 109 to display a comparison result between each total number of registered commodities and each total placement number of commodities on the placing portion 4. If any total number of registered commodities is different from the total placement number of commodities based on the comparison result, the display control unit 1012 may display the total placement number of commodities in a display form different from that of the total number of registered commodities. For example, if the number of registered commodity A is three and the total placement number of commodity A is two, the display control unit 1012 displays characters of the total placement number of commodity A in a color different from a color of characters of the number of registered commodity A. The display control unit 1012 may also cause the display device 109 to display a notification based on the comparison result. The notification is, for example, a text display indicating that the total number of registered commodities is different from the total placement number of commodities. The display control unit 1012 may cause the display device 109 to display the notification in any form such as a symbol, an icon, or a video. The processor 101 may cause a sound output device (not illustrated) to output the notification as a sound.

According to this example, the determination unit 1010 can determine the change in weight of the commodities measured by the weight sensor 2 provided in the placing portion 4. The update unit 1011 can update the first total placement number of commodities on the placing portion 4 based on the determination of the change in weight of the commodities placed on the placing portion 4 by the determination unit 1010. The display control unit 1012 can cause the display device 109 to display the first total placement number updated by the update unit 1011. As a result, every time a commodity is placed on the placing portion 4, the POS terminal 1 can display the first total placement number based on the measurement result of the weight sensor 2. Therefore, the store clerk can recognize the total number of commodities placed on the placing portion 4 via the display device 109. The store clerk can compare a total number of registered purchased commodities with the total number of commodities placed on the placing portion 4 based on the first total placement number displayed on the display device 109. In this manner, the POS terminal 1 gives the store clerk a chance to check the total number of commodities placed on the placing portion 4, and the purchased commodities can be prevented from being forgotten to be passed to the customer.

According to this example, the update unit 1011 can update the first total placement number in response to the commodity being a light weight commodity based on the commodity information on the commodity acquired by the commodity information acquisition unit 1013. As a result, even if the commodity placed on the placing portion 4 has a light weight and the weight cannot be measured by the weight sensor 2, the POS terminal 1 can update the first total placement number according to the number of placed commodities. Therefore, even if the commodities placed on the placing portion 4 include a light weight commodity, the store clerk can recognize the total placement number of commodities via the display device 109. Further, even if the commodity cannot be measured by the weight sensor 2, the store clerk can compare the total number of registered purchased commodities with the total number of commodities placed on the placing portion 4 based on the first total placement number displayed on the display device 109. In this manner, even if the purchased commodities include a light weight commodity, the POS terminal 1 gives the store clerk a chance to check the total number of commodities placed on the placing portion 4, and the purchased commodities can be prevented from being forgotten to be passed to the customer.

According to this example, the update unit 1011 can calculate the increased number of commodities placed on the placing portion 4 by using the standard weight of the commodity and the change amount of the weight determined by the determination unit 1010, based on the commodity information on the commodity acquired by the commodity information acquisition unit 1013. The update unit 1011 can update the first total placement number based on the increased number. Accordingly, even if a plurality of the same commodities are registered and placed on the placing portion 4 by the store clerk, the POS terminal 1 can update the first total placement number based on the calculated increased number of commodities placed on the placing portion 4. Therefore, even if a plurality of the same commodities are registered, the store clerk can compare the total number of registered purchased commodities with the total number of commodities placed on the placing portion 4 based on the first total placement number displayed on the display device 109. In this manner, even if the purchased commodities include a plurality of the same commodities, the POS terminal 1 gives the store clerk a chance to check the total number of commodities placed on the placing portion 4, and the purchased commodities can be prevented from being forgotten to be passed to the customer.

According to this example, every time the commodity is registered by the store clerk via the scanner 107, the display control unit 1012 can cause the display device 109 to display the total number of registered commodities. The display control unit 1012 can cause the display device 109 to display the comparison result between the total number of registered commodities and the first total placement number. As a result, every time a commodity is placed on the placing portion 4, the POS terminal 1 displays the total number of registered commodities and the first total placement number. If the first total placement number is different from the total number of registered commodities, the POS terminal 1 can warn the store clerk. Therefore, via the display device 109, the store clerk can easily recognize the total number of registered commodities and the total number of commodities placed on the placing portion 4, and can easily recognize a difference between the total number of registered commodities and the total placement number of commodities. In this manner, the POS terminal 1 gives the store clerk a chance to check the total number of registered commodities and the total number of commodities placed on the placing portion 4, and the purchased commodities can be prevented from being forgotten to be passed to the customer.

According to this example, every time a commodity is registered, the display control unit 1012 can cause the display device 109 to display each total number of registered commodities in addition to the total number of registered commodities or instead of the total number of registered commodities. As a result, every time a commodity is placed on the placing portion 4, the POS terminal 1 can display each total placement number of commodities based on the measurement result of the weight sensor 2. Therefore, the store clerk can recognize each total number of commodities placed on the placing portion 4 via the display device 109. The store clerk can compare each total number of registered purchased commodities with each total number of commodities placed on the placing portion 4 based on each total placement number of commodities displayed on the display device 109. In this manner, the POS terminal 1 gives the store clerk a chance to check the total number of commodities placed on the placing portion 4, and each type of the purchased commodity can be prevented from being forgotten to be passed to the customer.

The display control unit 1012 can cause the display device 109 to display the comparison result between each total number of registered commodities and each total placement number of commodities on the placing portion 4. As a result, if any total placement number of commodities is different from the total number of registered commodities, the POS terminal 1 can warn the store clerk. Therefore, via the display device 109, the store clerk can easily recognize each total number of registered commodities and each total number of commodities placed on the placing portion 4, and can easily recognize a difference between the total number of registered commodities and the total placement number of commodities. In this manner, the POS terminal 1 gives the store clerk a chance to check each total number of registered commodities and each total number of commodities placed on the placing portion 4, and each type of the purchased commodity can be prevented from being forgotten to be passed to the customer.

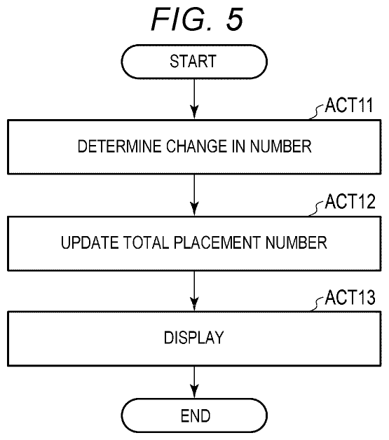

FIG. 5 is a flowchart illustrating another example of the procedure of information processing performed by the processor 101 of the POS terminal 1. In this example, an example of a procedure of information processing using the measurement result of the pressure distribution sensor 3 will be described.

The determination unit 1010 determines the change in the number of commodities based on the pressure distribution in the placing portion 4 measured by the pressure distribution sensor 3 provided in the placing portion 4 (ACT 11). In ACT 11, for example, the determination unit 1010 acquires, from the pressure distribution sensor 3 via the communication interface 106, the pressure distribution data indicating the pressure distribution in the placing portion 4 according to the commodities placed on the placing portion 4 that is measured by the pressure distribution sensor 3. For example, the determination unit 1010 specifies center-of-gravity positions of the commodities placed on the placing portion 4 based on the pressure distribution data, and determines the number of commodities based on the number of center-of-gravity positions. The determination unit 1010 may determine the number of commodities placed on the placing portion 4 based on the pressure distribution data by using a known technique such as recognition of a pressure distribution pattern for each commodity. The determination unit 1010 compares the number of commodities on the placing portion 4 before the commodity A is placed on the placing portion 4 with the number of commodities based on the pressure distribution data. The determination unit 1010 determines the change in the number of commodities on the placing portion 4 based on a comparison result. The determination unit 1010 stores the determined change in the number of commodities in the auxiliary storage device 103. The determined change in the number of commodities is also referred to as the increased number. For example, a case in which the store clerk registers the commodity A two times and places the commodities A on the placing portion 4 will be described. The determination unit 1010 specifies the center-of-gravity positions of the commodities placed on the placing portion 4 based on the pressure distribution data. The determination unit 1010 determines that the number of commodities is increased by two from the number of center-of-gravity positions of the specified commodities. The determination unit 1010 determines that the increased number of commodities A is 2.

The update unit 1011 updates the second total placement number of commodities on the placing portion 4 based on the determination of the change in the number of commodities by the determination unit 1010 (ACT 12). In ACT 12, for example, the update unit 1011 updates the second total placement number of commodities placed on the placing portion 4 based on the increased number determined in ACT 11. For example, in ACT 11, if the determination unit 1010 determines that the increased number of commodities A is 2, the update unit 1011 adds the number “2” of commodities A to the second total placement number.

The display control unit 1012 controls the display of the display device 109 (ACT 13).

The display control unit 1012 causes the display device 109 to display the total number of registered commodities registered via the scanner 107. For example, every time a commodity is registered, the display control unit 1012 acquires the total number of registered commodities stored in the auxiliary storage device 103. The display control unit 1012 causes the display device 109 to display the acquired total number of registered commodities. Alternatively, every time a commodity is registered, the display control unit 1012 may acquire each total number of registered commodities from the auxiliary storage device 103 in addition to the total number of registered commodities or instead of the total number of registered commodities, and causes the display device 109 to display each total number of registered commodities.

The display control unit 1012 causes the display device 109 to display the second total placement number updated by the update unit 1011. Alternatively, every time the pressure distribution in the placing portion 4 is measured by the pressure distribution sensor 3, the display control unit 1012 may cause the display device 109 to display each total placement number of commodities in addition to the second total placement number or instead of the second total placement number.

The display control unit 1012 causes the display device 109 to display a comparison result between the total number of registered commodities and the second total placement number. If the second total placement number is different from the total number of registered commodities based on the comparison result, the display control unit 1012 may display the second total placement number in a display form different from that of the total number of registered commodities. For example, if the total number of registered commodities is 10 and the second total placement number is 9, the display control unit 1012 displays characters of the second total placement number in a color different from the color of the characters of the total number of registered commodities. The display control unit 1012 may also cause the display device 109 to display a notification based on the comparison result. The notification is, for example, a text display indicating that the second total placement number is different from the total number of registered commodities. The display control unit 1012 may cause the display device 109 to display the notification in any form such as a symbol, an icon, or a video. The processor 101 may cause the sound output device (not illustrated) to output the notification as a sound.

The display control unit 1012 may cause the display device 109 to display a comparison result between each total number of registered commodities and each total placement number of commodities on the placing portion 4. If any total number of registered commodities is different from the total placement number of commodities based on the comparison result, the display control unit 1012 may display the total placement number of commodities in a display form different from that of the total number of registered commodities. For example, if the number of registered commodity A is three and a total placement number of commodity A is two, the display control unit 1012 displays characters of the total placement number of commodity A in a color different from a color of characters of the number of registered commodity A. The display control unit 1012 may cause the display device 109 to display a notification based on the comparison result between each total number of registered commodities and each total placement number of commodities. The notification is, for example, a text display indicating that the total number of registered commodities is different from the total placement number of commodities. The display control unit 1012 may cause the display device 109 to display the notification in any form such as a symbol, an icon, or a video. The processor 101 may cause the sound output device (not illustrated) to output the notification as a sound.

According to this example, the determination unit 1010 can determine the change in the number of commodities based on the pressure distribution in the placing portion 4 measured by the pressure distribution sensor 3 provided in the placing portion 4. The update unit 1011 can update the second total placement number of commodities on the placing portion 4 based on the determination of the change in the number of the commodities placed on the placing portion 4 by the determination unit 1010. The display control unit 1012 can cause the display device 109 to display the second total placement number updated by the update unit 1011. As a result, every time a commodity is placed on the placing portion 4, the POS terminal 1 can display the second total placement number based on the measurement result of the pressure distribution sensor 3. Therefore, the store clerk can recognize the total number of commodities placed on the placing portion 4 via the display device 109. The store clerk can compare a total number of registered purchased commodities with the total number of commodities placed on the placing portion 4. In this manner, the POS terminal 1 gives the store clerk a chance to check the total number of commodities placed on the placing portion 4, and the purchased commodities can be prevented from being forgotten to be passed to the customer.

According to this example, every time the commodity is registered by the store clerk via the scanner 107, the display control unit 1012 can cause the display device 109 to display the total number of registered commodities. The display control unit 1012 can cause the display device 109 to display the comparison result between the total number of registered commodities and the second total placement number. As a result, if the second total placement number is different from the total number of registered commodities, the POS terminal 1 can warn the store clerk. Therefore, the store clerk can easily recognize the total number of registered commodities and the total number of commodities placed on the placing portion 4 via the display device 109. In this manner, the POS terminal 1 gives the store clerk a chance to check the total number of registered commodities and the total number of commodities placed on the placing portion 4, and the purchased commodities can be prevented from being forgotten to be passed to the customer.

According to this example, every time a commodity is registered, the display control unit 1012 can cause the display device 109 to display each total number of registered commodities in addition to the total number of registered commodities or instead of the total number of registered commodities. As a result, every time a commodity is placed on the placing portion 4, the POS terminal 1 can display each total placement number of commodities based on the measurement result of the pressure distribution sensor 3. Therefore, the store clerk can recognize each total number of commodities placed on the placing portion 4 via the display device 109. The store clerk can compare each total number of registered purchased commodities with each total number of commodities placed on the placing portion 4 based on each total placement number of commodities displayed on the display device 109. In this manner, the POS terminal 1 gives the store clerk a chance to check the total number of commodities placed on the placing portion 4, and each type of the purchased commodity can be prevented from being forgotten to be passed to the customer.

The display control unit 1012 can cause the display device 109 to display the comparison result between each total number of registered commodities and each total placement number of commodities on the placing portion 4. As a result, if any total placement number of commodities is different from the total number of registered commodities, the POS terminal 1 can warn the store clerk. Therefore, via the display device 109, the store clerk can easily recognize each total number of registered commodities and each total number of commodities placed on the placing portion 4, and can easily recognize a difference between the total number of registered commodities and the total placement number of commodities. In this manner, the POS terminal 1 gives the store clerk a chance to check each total number of registered commodities and each total number of commodities placed on the placing portion 4, and each type of the purchased commodity can be prevented from being forgotten to be passed to the customer.

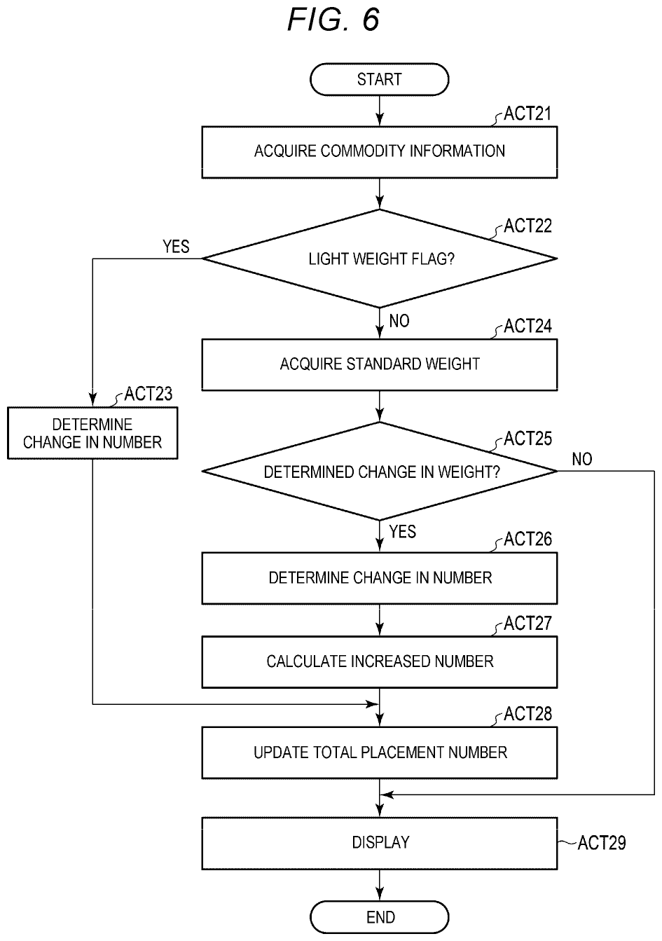

FIG. 6 is a flowchart illustrating still another example of the procedure of information processing performed by the processor 101 of the POS terminal 1. In this example, an example of a procedure of information processing using the measurement results of the weight sensor 2 and the pressure distribution sensor 3 will be described.

The commodity information acquisition unit 1013 acquires the commodity information on the commodity A registered via the scanner 107 based on the commodity information 1031 (ACT 21). The processing of ACT 21 is the same as the processing of ACT 1.

The commodity information acquisition unit 1013 determines whether the commodity A is a lightweight commodity based on the acquired commodity information on the commodity A (ACT 22). The processing of ACT 22 is the same as the processing of ACT 2. If the commodity information acquisition unit 1013 determines that the light weight flag is set to “1” (ACT 22: YES), the process transitions from ACT 22 to ACT 23. If the commodity information acquisition unit 1013 determines that the light weight flag is not set to “1” (ACT 22: NO), the process transitions from ACT 22 to ACT 24.

The determination unit 1010 determines the change in the number of commodities based on the pressure distribution in the placing portion 4 measured by the pressure distribution sensor 3 provided in the placing portion 4 (ACT 23). The processing of ACT 23 is the same as the processing of ACT 11.

The commodity information acquisition unit 1013 acquires the standard weight of the commodity A based on the acquired commodity information on the commodity A (ACT 24). The processing of ACT 24 is the same as the processing of ACT 3.

The determination unit 1010 determines the change in weight of the commodities measured by the weight sensor 2 provided in the placing portion 4 (ACT 25). The processing of ACT 25 is the same as the processing of ACT 4. If the determination unit 1010 determines that the weight of the commodity placed on the placing portion 4 is changed (ACT 25: YES), the process transitions from ACT 25 to ACT 26. If the determination unit 1010 determines that the weight of the commodity placed on the placing portion 4 is not changed (ACT 25: NO), the process transitions from ACT 25 to ACT 29.

The determination unit 1010 determines the change in the number of commodities based on the pressure distribution in the placing portion 4 measured by the pressure distribution sensor 3 provided in the placing portion 4 (ACT 26). The processing of ACT 26 is the same as the processing of ACT 11.

The update unit 1011 calculates the increased number of commodities A placed on the placing portion 4 based on the change weight determined by the determination unit 1010 in ACT 25 (ACT 27). The processing of ACT 27 is the same as the processing of ACT 5.

The update unit 1011 updates the total placement number of commodities on the placing portion 4 (ACT 28).

The update unit 1011 updates the first total placement number of commodities on the placing portion 4.

In one example, the update unit 1011 updates the first total placement number of commodities placed on the placing portion 4 in response to the determination that the commodity A is a light weight commodity in ACT 22. In this case, the update unit 1011 acquires the number of commodities A stored in the auxiliary storage device 103. The update unit 1011 adds the acquired number of commodities A to the first total placement number. A case in which the commodity A is the commodity having the commodity code “00002” and the store clerk registers the commodity A two times will be described. The update unit 1011 acquires the number “2” of registered commodities A from the auxiliary storage device 103. The update unit 1011 adds the number “2” of commodities A to the first total placement number.

In another example, the update unit 1011 updates the first total placement number of commodities placed on the placing portion 4 based on the increased number of commodities calculated in ACT 27. For example, if the increased number of commodities calculated in ACT 27 is 2, the number “2” of commodities A is added to the first total placement number.

The update unit 1011 updates the second total placement number of commodities on the placing portion 4. For example, the update unit 1011 updates the second total placement number of commodities placed on the placing portion 4 based on the increased number determined in ACT 23 or ACT 26. For example, if the increased number of commodities calculated in ACT 23 or ACT 26 is 2, the update unit 1011 adds the number “2” of commodities A to the second total placement number.

The display control unit 1012 controls the display of the display device 109 (ACT 29).

The display control unit 1012 causes the display device 109 to display the total number of registered commodities registered via the scanner 107. For example, every time a commodity is registered, the display control unit 1012 acquires the total number of registered commodities stored in the auxiliary storage device 103. The display control unit 1012 causes the display device 109 to display the acquired total number of registered commodities. Alternatively, every time a commodity is registered, the display control unit 1012 may acquire each total number of registered commodities from the auxiliary storage device 103 in addition to the total number of registered commodities or instead of the total number of registered commodities, and cause the display device 109 to display each total number of registered commodities.

The display control unit 1012 causes the display device 109 to display the first total placement number updated by the update unit 1011. Alternatively, every time a weight of a commodity placed on the placing portion 4 is measured by the weight sensor 2, the display control unit 1012 may cause the display device 109 to display each total placement number of commodities in addition to the first total placement number or instead of the first total placement number.

The display control unit 1012 causes the display device 109 to display the second total placement number updated by the update unit 1011. Alternatively, every time the pressure distribution in the placing portion 4 is measured by the pressure distribution sensor 3, the display control unit 1012 may cause the display device 109 to display each total placement number of commodities in addition to the second total placement number or instead of the second total placement number.

The display control unit 1012 causes the display device 109 to display the comparison result between the total number of registered commodities and the first total placement number. If the first total placement number is different from the total number of registered commodities based on the comparison result, the display control unit 1012 may display the first total placement number in a display form different from that of the total number of registered commodities.

The display control unit 1012 causes the display device 109 to display a comparison result between the total number of registered commodities and the second total placement number. If the second total placement number is different from the total number of registered commodities based on the comparison result, the display control unit 1012 may display the second total placement number in a display form different from that of the total number of registered commodities. The display control unit 1012 may make the display form when the second total placement number is different from the total number of registered commodities the same as or different from the display form when the first total placement number is different from the total number of registered commodities.

The display control unit 1012 may cause the display device 109 to display the comparison results of the total number of registered commodities with the first total placement number, and the total number of registered commodities with the second total placement number. If at least one of the first total placement number and the second total placement number is different from the total number of registered commodities based on the comparison result, the display control unit 1012 may display the at least one of the first total placement number and the second total placement number in a display form different from that of the total number of registered commodities. For example, a case in which the total number of registered commodities is 10, the first total placement number is 10, and the second total placement number is 9 will be described. The display control unit 1012 may display the characters of the second total placement number in a color different from colors of the characters of the total number of registered commodities and the first total placement number. In this case, the display control unit 1012 may display the characters of the second total placement number in red, and the characters of the total number of registered commodities and the first total placement number in blue. Next, a case in which the total number of registered commodities is 10, the first total placement number is 9, and the second total placement number is 8 will be described. The display control unit 1012 may display the characters of the first total placement number and the second total placement number in a color different from a color of the characters of the total number of registered commodities. In this case, the display control unit 1012 may display the characters of the first total placement number and the second total placement number in yellow, and the characters of the total number of registered commodities in blue.

The display control unit 1012 may cause the display device 109 to display a notification based on the comparison result between the total number of registered commodities and the first total placement number. The notification is, for example, a text display indicating that the first total placement number is different from the total number of registered commodities. The display control unit 1012 may cause the display device 109 to display a notification based on the comparison result between the total number of registered commodities and the second total placement number. The notification is, for example, a text display indicating that the second total placement number is different from the total number of registered commodities. The display control unit 1012 may cause the display device 109 to display the notifications based on the comparison results of the total number of registered commodities with the first total placement number, and the total number of registered commodities with the second total placement number. The notification is, for example, a text display indicating that the total number of registered commodities is different from at least one of the first total placement number and the second total placement number. The display control unit 1012 may cause the display device 109 to display the notification in any form such as a symbol, an icon, or a video. The processor 101 may cause the sound output device (not illustrated) to output the notification as a sound.

The display control unit 1012 may cause the display device 109 to display a comparison result between each total number of registered commodities and each total placement number of commodities on the placing portion 4. If any total number of registered commodities is different from the total placement number of commodities based on the comparison result, the display control unit 1012 may display each total placement number of commodities in a display form different from that of each total number of registered commodities. For example, a case in which the number of registered commodities A is three and the total placement number of commodities A based on the weight sensor 2 is two will be described. The display control unit 1012 displays characters of the total placement number of commodities A based on the weight sensor 2 in a color different from a color of characters of the number of registered commodities A. Next, a case in which the number of registered commodities A is three, the total placement number of commodities A based on the weight sensor 2 is two, and the total placement number of commodities A based on the pressure distribution sensor 3 is two will be described. The display control unit 1012 displays characters of the total placement number of commodities A based on the weight sensor 2 and the total placement number of commodities Abased on the pressure distribution sensor 3 in a color different from a color of the characters of the number of registered commodities A. The display control unit 1012 may cause the display device 109 to display a notification based on the comparison result between each total number of registered commodities and each total placement number of commodities on the placing portion 4. The notification is, for example, a text display indicating that the total number of registered commodities is different from the total placement number of commodities. The display control unit 1012 may cause the display device 109 to display the notification in any form such as a symbol, an icon, or a video. The processor 101 may cause the sound output device (not illustrated) to output the notification as a sound.

According to this example, every time the commodity is registered by the store clerk via the scanner 107, the display control unit 1012 can cause the display device 109 to display the total number of registered commodities. The display control unit 1012 can cause the display device 109 to display the comparison results of the total number of registered commodities with the first total placement number, and the total number of registered commodities with the second total placement number. As a result, if at least one of the first total placement number and the second total placement number is different from the total number of registered commodities, the POS terminal 1 can warn the store clerk. Therefore, via the display device 109, the store clerk can easily recognize the total number of registered commodities and the total number of commodities placed on the placing portion 4, and can easily recognize a difference between the total number of registered commodities and the at least one of the first total placement number and the second total placement number. In this manner, the POS terminal 1 gives the store clerk a chance to check the total number of registered commodities and the total number of commodities placed on the placing portion 4, and the purchased commodities can be prevented from being forgotten to be passed to the customer.

According to this example, every time a commodity is registered, the display control unit 1012 can cause the display device 109 to display each total number of registered commodities in addition to the total number of registered commodities or instead of the total number of registered commodities. The display control unit 1012 can cause the display device 109 to display the comparison result between each total number of registered commodities and each total placement number of commodities on the placing portion 4 based on the measurement results of the weight sensor 2 and the pressure distribution sensor 3. As a result, if any total placement number of commodities based on the weight sensor 2 and the pressure distribution sensor 3 is different from the total number of registered commodities, the POS terminal 1 can warn the store clerk. Therefore, via the display device 109, the store clerk can easily recognize each total number of registered commodities and each total number of commodities placed on the placing portion 4 based on the weight sensor 2 and the pressure distribution sensor 3, and can easily recognize a difference between the total number of registered commodities and the total placement number of commodities. In this manner, the POS terminal 1 gives the store clerk a chance to check each total number of registered commodities and each total number of commodities placed on the placing portion 4, and each type of the purchased commodity can be prevented from being forgotten to be passed to the customer.

In the above-described embodiment, the POS terminal 1 with which the store clerk performs the operations from the registration to the settlement on the purchased commodity is illustrated, but the disclosure is not limited thereto. At least a part of functions of the POS terminal 1 may be implemented in a so-called semi-self-service-type settlement apparatus with which a store clerk registers a purchased commodity and a customer performs settlement. The semi-self-service-type settlement apparatus is an example of the information processing apparatus, similarly to the POS terminal 1. At least a part of functions of the POS terminal 1 may be implemented in a so-called full-self-service POS terminal with which a customer performs the operations from the registration to the settlement on a purchased commodity. The full-self-service POS terminal is an example of the information processing apparatus, similarly to the POS terminal 1.

Further, at least a part of functions of the POS terminal 1 may be implemented in a so-called cart POS terminal in which a commodity scanner and a dedicated terminal operated by a customer are attached to a cart. At least a part of functions of the POS terminal 1 may be implemented in a so-called smartphone POS terminal in which commodity registration is performed by a terminal such as a tablet or a smartphone. The cart POS terminal and the smartphone POS terminal are examples of the information processing apparatus, similarly to the POS terminal 1.

In the above-described embodiment, the commodity is described as an example, but the disclosure is not limited thereto. The above-described embodiment may be applied to not only an article to be a target of a transaction involving the settlement, such as the commodity, but also to an article without involving the settlement. For example, the article not involving the settlement is a book or the like of a library. The notation of “commodity” may be interpreted as “article”.

The information processing apparatus may be implemented by a single apparatus as described using the POS terminal 1 as an example, or may be implemented by a system in which functions are distributed to a plurality of apparatuses.

The program may be transferred in a state of being stored in an electronic device, or may be transferred in a state without being stored in an electronic device. In the latter case, the program may be transferred via a network, or may be transferred in a state of being recorded in a recording medium. The recording medium is a non-transitory tangible medium. The recording medium is a medium that can be read by an electronic device. The recording medium may be a medium such as a CD-ROM or a memory card that can store a program and can be read by an electronic device, and a form thereof is not limited.

In addition, the embodiment has been described, but the embodiment is presented only as an example, and is not intended to limit the scope of the disclosure. Indeed, the novel embodiment described herein may be embodied in a variety of other forms; furthermore, various omissions, substitutions and changes in the form of the embodiment described herein may be made without departing from the spirit of the disclosure. The embodiment and a modification thereof are included in the scope and the spirit of the disclosure and are also included in the invention described in the scope of claims and an equivalent scope thereof.

What is claimed is:

1. An information processing apparatus comprising:
a processor configured to:
determine a change in weight of commodities measured by a weight sensor provided in a placing portion;
update a first total placement number of commodities on the placing portion based on the determination of the change in weight; and
cause a display to display the updated first total placement number.

2. The apparatus according to claim 1, wherein the processor is further configured to:
acquire commodity information relating to registered commodities, and
update the first total placement number in response to the commodity being a light weight commodity based on the commodity information relating to the acquired commodity.

3. The apparatus according to claim 1, the processor further configured to:
acquire commodity information relating to registered commodities,
calculate an increased number of commodities placed on the placing portion by using a standard weight of the commodity and a change amount of the weight determined by the processor, based on the commodity information relating to the acquired commodity, and
update the first total placement number based on the increased number.

4. The apparatus according to claim 1, wherein
the processor is configured to cause the display to display a total number of registered commodities every time a commodity is registered, and cause the display to display a comparison result between the total number of registered commodities and the first total placement number.

5. The apparatus according to claim 1, wherein
the processor is configured to:
determine a change in the number of commodities based on a pressure distribution in the placing portion measured by a pressure distribution sensor provided in the placing portion,
update a second total placement number of commodities on the placing portion based on the determination of the change in the number of commodities, and
cause the display to display the second total placement number updated by the update.

6. The apparatus according to claim 1, wherein the information processing apparatus include a point of sale terminal.

7. The apparatus according to claim 2, wherein the apparatus is configured to acquire the commodity information by reading a commodity code.

8. The apparatus according to claim 4, wherein the processor is configured to cause the display to display a notification based on the comparison result.

9. The apparatus according to claim 8, wherein the notification includes one of text, a symbol, an icon or a video.

10. An information processing system comprising:
a weight sensor provided in a placing portion, the weight sensor being configured to measure a weight of one or more commodities; and
an information processing apparatus comprising a processor configured to:
determine a change in weight of the one or more commodities measured by the weight sensor,
update a first total placement number of commodities on the placing portion based on the determination of the change in weight, and
cause a display to display the updated first total placement number.

11. The information system according to claim 10, wherein the processor is further configured to:
acquire commodity information on registered commodities, and
update the first total placement number in response to the commodity being a light weight commodity based on the commodity information relating to the acquired commodity.

12. The information system according to claim 10, wherein the processor is further configured to:
acquire commodity information on registered commodities;
calculate an increased number of commodities placed on the placing portion by using a standard weight of the commodity and a change amount of the weight determined by the processor, based on the commodity information relating to the acquired commodity, and
update the first total placement number based on the increased number.

13. The information system according to claim 10, wherein
the processor is configured to cause the display to display a total number of registered commodities every time a commodity is registered, and cause the display to display a comparison result between the total number of registered commodities and the first total placement number.

14. The information system according to claim 10, wherein
the processor is configured to:
determine a change in the number of commodities based on a pressure distribution in the placing portion measured by a pressure distribution sensor provided in the placing portion,
update a second total placement number of commodities on the placing portion based on the determination of the change in the number of commodities, and
cause the display to display the second total placement number updated by the update.

15. An information processing method comprising:
determining a change in weight of commodities measured by a weight sensor provided in a placing portion;
updating a first total placement number of commodities on the placing portion based on the determination of the change in weight; and
causing a display to display the updated first total placement number.
